(19) United States
(12) Patent Application Publication
(10) Pub. No.: US 2011/0032717 A1
(43) Pub. Date: Feb. 10, 2011

(54) Light control device for vehicles

(75) Inventors: Tomoyuki Kamitani, Nagoya (JP); Kazuhisa Okumura, Kariya-shi (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/806,069

(22) Filed: Aug. 5, 2010

(30) Foreign Application Priority Data
Aug. 7, 2009 (JP) 2009-184772

(51) Int. Cl. B60Q 1/08; B60Q 1/04

(52) U.S. Cl. 362/466; 362/465

(57) ABSTRACT

A light control device for vehicles that controls a light axis direction of a headlight in the vehicle has an inclination acquisition means that acquires a detection result of an inclination of the vehicle, and a light axis direction changing means that changes a direction of the light axis by a response modified by a predetermined filter, so that the light axis directions of the headlights approaches an angle beforehand set to align it with the road surface according to the acquired inclination of the vehicle.

### CROSS-REFERENCE TO RELATED APPLICATION

This application is based on and claims the benefit of priority from earlier Japanese Patent Application No. 2009-184772 filed Aug. 7, 2009, the description of which is incorporated herein by reference.

### BACKGROUND OF THE INVENTION

1. Technical Field of the Invention

The present invention relates to a light control device for vehicles that controls direction of a light axis of a headlight in the vehicles, and its light control program.

2. Description of the Related Art

In a typical light control device, for example as disclosed in the Japanese patent No. 3209933, the acceleration (accelerating or decelerating) of a vehicle is detected and the light axis is adjusted accordingly.

With the technology mentioned above, the problems occurring due to the frequent direction change of the light axis when the vehicle runs over bumps on the road while traveling is prevented by making the direction change of the light axis slow, while the direction change of the light axis is made quick and is changed into a suitable direction of the light axis promptly when the vehicle is accelerating or decelerating.

However, with the above-mentioned technology, since the response is changed some time after detecting the change of acceleration, there is a possibility that the response of changing the direction of the light axis can only be changed after the vehicle inclines by the change of acceleration.

For example, when the vehicle makes a sudden deceleration, the vehicle inclines because of the sudden deceleration, the direction of the light axis changes downwardly following the vehicle inclination, but too slowly to follow the change of vehicle inclination.

The response could be improved and the direction of the light axis will controlled upward quickly.

Thus, in the above-mentioned light control device, there is a problem of changing the direction of the light axis up and down too sharply.

There is a possibility that such a problem occurs similarly when the vehicle makes a sudden acceleration.

### SUMMARY OF THE INVENTION

The present invention has been made in order to solve the issue described above, and has as its object to provide a light control device for vehicles that can prevent the problems caused by frequent changes of the direction of the light axis as well as to prevent the direction of the light axis changing up and down sharply when the vehicle is accelerating/decelerating.

In a light control device for vehicles according to a first aspect, the light control device for vehicles that controls a light axis direction of a headlight in the vehicles comprises an inclination acquisition means that acquires a detection result of an inclination of the vehicle, and a light axis direction changing means that changes a direction of the light axis by a response modified by a predetermined filter, so that the light axis direction of the headlight approaches an angle beforehand set to align it with the road surface according to the acquired inclination of the vehicle.

The light control device for vehicles further comprises an operation acquisition means that acquires a detection result of a changing operation in which a driver of the vehicle performs a change of speed or acceleration of the vehicle, and a filter setting means that either selects a filter giving a better response or selects no filter as appropriate for giving the best response characteristics (responsiveness) according to a detection result of the changing operation by the driver of the vehicle.

According to the light control device, the inclination of the vehicle changed by acceleration or deceleration is detectable in advance by detecting the changing operation that gives a change in speed or acceleration.

Before the inclination of the vehicle changes, the filter that determines the response at the time of making the light axis directions change may be changed into a filter that can change the light axis directions promptly or a filter not to be used (to provide the best response).

Therefore, at times other than during acceleration or deceleration of the vehicle, the troublesome frequent light axis changes can be prevented, and sharp up and down changing of the light axis directions can be prevented during acceleration or deceleration.

In the light control device for vehicles according to a second aspect, the filter setting means presumes that the detection result of the changing operation by the driver of the vehicles is acquired when the detection result of the changing operation is acquired continuously in a judging standard time set as within a time after the driver of the vehicles performs the changing operation until an acceleration or speed of the vehicles actually changes.

In the light control device for vehicles according to a third aspect, the operation acquisition means acquires the detection result of an operation of an accelerator or a brake of the vehicles as the changing operation.

In the light control device for vehicles according to a fourth aspect, a computer is made to function by a light control program as a means to constitute the light control device.

### BRIEF DESCRIPTION OF THE DRAWINGS

In the accompanying drawings:

FIG. 1 shows an outline of a whole composition of a light control device;

FIG. 2 shows a flow chart of a light control process;

FIG. 3 shows a flow chart of a control mode determination process; and

FIG. 4 shows a flow chart of an operation judging control process.

### DETAILED DESCRIPTION OF THE PREFERRED EMBODIMENTS

A preferred embodiment according to the present invention will be described with reference to the drawings.

### Composition of the Embodiment

A light control device 1 is equipped in a vehicle, such as a passenger car, and is a device that has a function of controlling directions of light axes of headlights 30L and 30R.

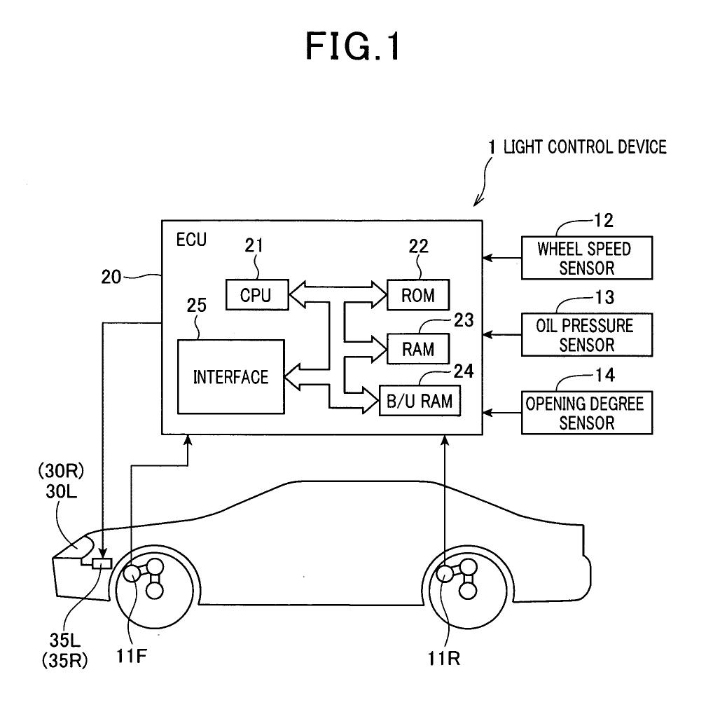

Specifically, suspension systems (not shown) are provided between a vehicle body and axles; the suspension systems and the axles are arranged in front and rear of the vehicle. As shown in FIG. 1, a front (front wheel) side height sensor (car height sensor) 11F and a rear (rear wheel) side height sensor (car height sensor) 11R are attached onto the front and rear suspension systems, respectively, in either a driver's seat side or a passenger's seat side.

A front height value (displacement value of the car height in the front wheel side) HF and a rear height value (displacement value of the car height in the rear wheel side) HR, as a relative displacement value of the vehicle body and axles of the front and rear wheels (displacement of the car height), is inputted from the height sensors 11F and 11R into an ECU (Electronic Control Unit) 20 equipped in the vehicle.

Various sensor signals, such as a wheel speed pulse generated by a wheel speed sensor 12, an oil pressure sensor 13 that detects brake oil pressure, and an accelerator opening degree sensor 14 that detects an opening degree of the accelerator, are also inputted into the ECU 20.

The ECU 20 and the wheel speed sensor 12 etc. are drawn outside of the vehicle in FIG. 1 for convenience.

The ECU 20 is constituted with a CPU 21, a ROM 22, a RAM 23, a B/U (backup) RAM 24, an interface circuit 25, and bus lines that connect these parts.

The CPU 21 functions as a well-known arithmetic device, and predetermined processes are operated based on the control program stored in the ROM 22, etc. The RAM 23 functions as a workspace for the CPU 21.

A setup made by a user, an operation result of an amount of control of the light axis of the headlight, etc. are recorded in the B/U RAM 24.

The interface circuit 25 has the function to filter the input and output (a pitch angle θp of the vehicle in the present embodiment) to the ECU 20.

Here, the output signal from the ECU 20 is inputted into each actuator 35L and 35R of the left and right headlights 30L and 30R of the vehicle, and as mentioned later, the light axis directions of the both headlights 30L and 30R are adjusted.

The various sensor signals from wheel speed sensor 12 etc. are used for the mode judging in the constant speed mode of vehicles, stop mode, acceleration mode, deceleration mode, etc.

Presuming the mechanism that changes light axes of lights equipped in the headlights 30L and 30R physically, it is necessary just to use a well-known composition; therefore a disclosure is omitted in this embodiment.

### Processing in the Embodiment

Next, calculation of the pitch angle θp of the longitudinal direction of the vehicle used with the light control device 1 of the present embodiment will be described.

The pitch angle θp [°], as an inclination angle to a base level where the longitudinal direction of the vehicle set up beforehand based on the front height value HF and the rear height value HR from the height sensors 11F and 11R among the various sensor signals of the vehicle inputted in the ECU 20, is computed by a following formula (1).

θp=tan⁻¹{(HF−HR)/Lw} (1)

Here, Lw is the wheelbase between the front wheel and the rear wheel.

The ECU 20 controls the amount of controlling the light axis directions (the amount of change) by applying a filter with a predetermined response to the pitch angle θp obtained from the above-mentioned formula (1) so that the light axis directions of the headlight 30L (30R) approach the angle beforehand set up to align correctly with the road surface based on the filtered pitch angle θpf.

For filtering, hardware that equalizes the height sensor signals (for example, smoothing of the signal by CR circuit) may be used, for example.

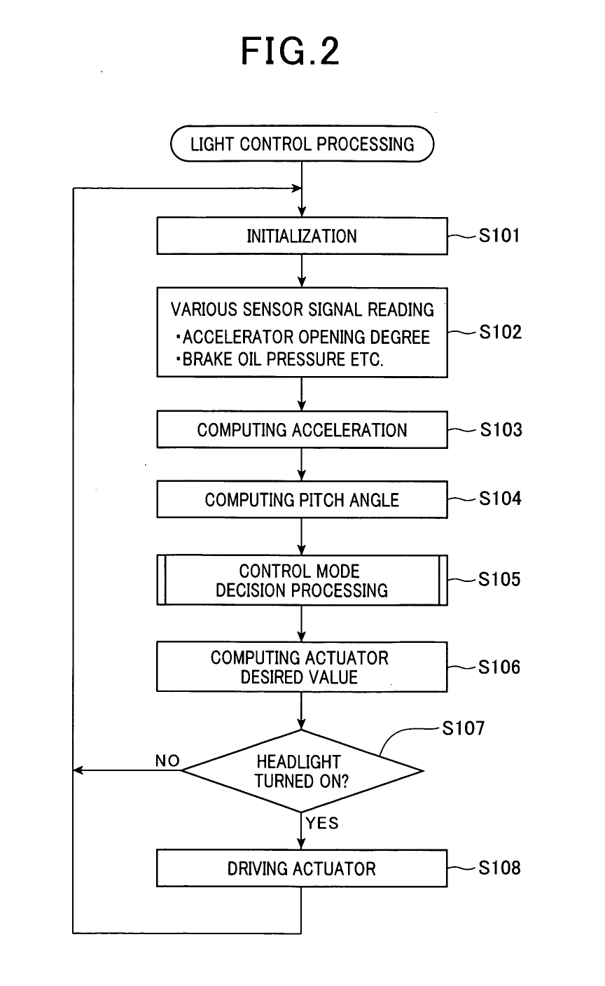

Details of processing by which the light control device 1 changes the light axis direction of the headlight 30L (30R) is explained using FIG. 2.

FIG. 2 is a flow chart that shows the light control process which the ECU 20 (CPU 21) performs. This processing is equivalent to a light control program as used in the present invention.

The light control process is started when a power supply of the vehicle, such as an ignition switch etc., is switched on, and the processing is repeated about every 50 ms after that, for example.

As the details of light control process are shown in FIG. 2, after an initial setup is performed (S101), various sensor signals, such as the wheel speed pulse, the front height value HF, the rear height value HR, the brake oil pressure value, and the opening degree of the accelerator, are read first (S102: inclination acquisition means, operation acquisition means).

Next, vehicle speed V calculated from the wheel speed pulse is differentiated, and acceleration α (=dV/dt) is computed (S103).

Then, the pitch angle θp (detection result of inclination of the vehicle) is computed by the above-mentioned formula (1) (S104: inclination acquisition means) based on the front height value HF and the rear height value HR that are obtained from the height sensors 11F and 11R.

Finally a below-mentioned control mode determination process is performed (S105).

When this control mode determination process ends, an actuator desired value (desired light axis direction adjustment angle) ea is computed (S106), which is θa≅−θpf that does not give glare to avoid dazzling an oncoming car, to the pitch angle θpf by which filter processing is carried out in each control mode determined by the processing.

Then whether the headlight 30L (30R) is currently turned on is judged (S107).

If the judgment condition of Step S107 is satisfied, and if headlight 30L (30R) is on (S107: YES), the actuator 35L (35R) is driven based on the computed actuator desired value θa (S108).

Then, when the light axis direction of the headlight 30L (30R) is adjusted, processing returns to S102 and the processing of S102-S107 will be performed henceforth repeatedly.

The processing of S105-S108 is equivalent to a light axis direction changing means as used in the present invention.

On the other hand, if the judgment condition of S107 if not satisfied, and the headlight 30L (30R) is not turned on (S107: NO), the step returns to S102 without driving the actuator 35L (35R), then processing of S102-S107 is performed repeatedly.

Next, the control mode determination process of the light control process is explained.

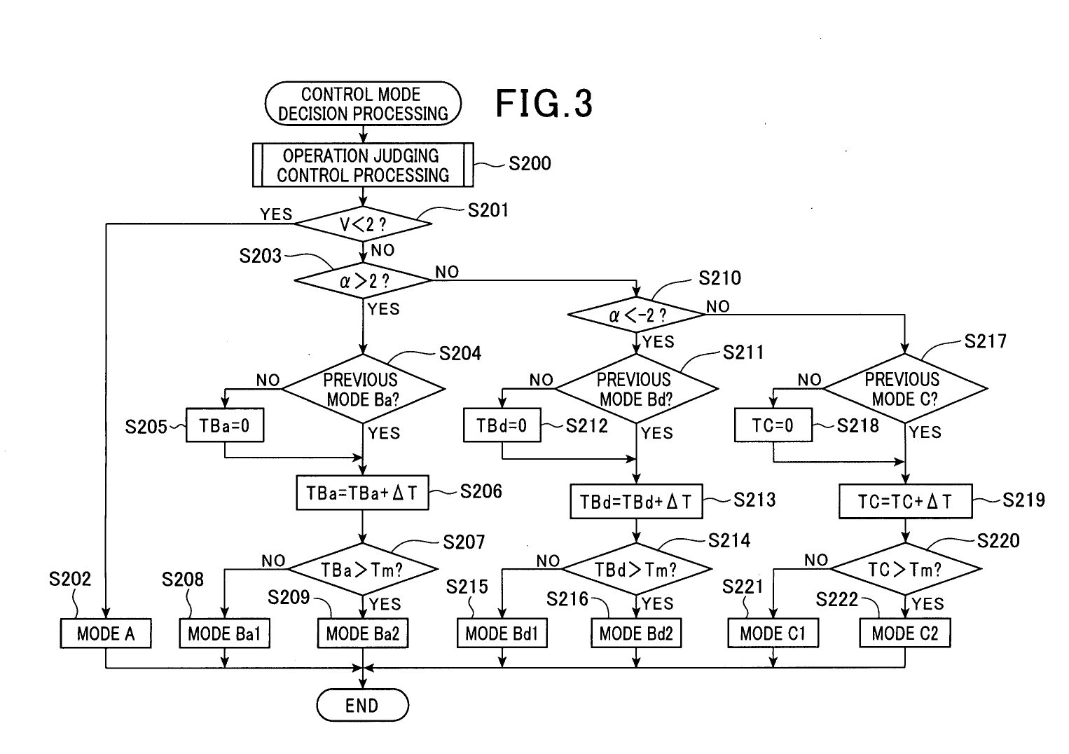

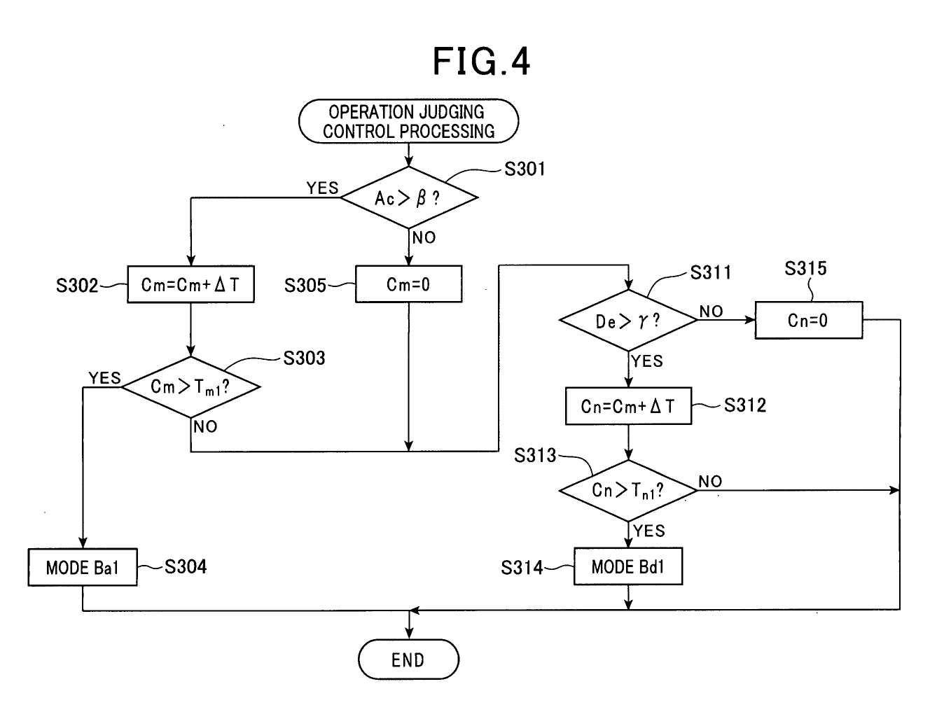

FIG. 3 is a flow chart that shows the control mode determination process, and FIG. 4 is a flow chart that shows the operation judging control process of the control mode determination process.

In the control mode determination process, the operation judging control process is performed first (S200: filter setting means).

In the operation judging control process, when the detection result of a changing operation (specifically operation of the accelerator or the brake) that changes speed or acceleration by the driver of the vehicle is acquired, the processing of setting either using the filter with a more sufficient response or not using the filter is performed as compared with the case where the changing operation is not acquired.

Specifically, as shown in FIG. 4, an opening degree of the accelerator Ac and a standard opening degree β is compared first (S301). Here, standard opening degree β is set to an arbitrary values of zero or more.

If Ac>β (S301: YES), a sampling interval ΔT is added to an accelerator counter Cm so that the accelerator counter Cm is considered as new (S302), and the accelerator counter Cm is compared with an accelerator standard timer value Tm1 (S303).

Here, the accelerator standard timer value Tm1 is set to a value that can detect that Ac>β is continued twice or more in order to eliminate the influence of noise (for example, value for 100 ms or more).

However, the accelerator standard timer value Tm1 is set as the time within time after the accelerator is operated until the speed (acceleration) of the vehicle actually changes.

The processing of S302 and S303 eliminates the influence of noise, and only an intention that the driver is going to accelerate the vehicle is detected.

If Cm>Tm1 (S303: YES), an acceleration mode Ba1 corresponding to a Ba1 filter (with no filter (or filter reset)) is decided so that the actuator can respond quickly to the pitch angle change without filtering (S304), and the operation judging control process is ended.

If Cm≦Tm1 (S303: NO), processing will continue to S311 mentioned later.

On the other hand, if Ac≦β (S301: NO) in the processing of S301, the accelerator counter Cm is reset (set to 0) (S305).

Next, the brake oil pressure De is compared with an oil pressure value γ used as a standard (S311). As for the oil pressure value γ used as the standard, arbitrary values of zero or more are set.

If De>γ (S311: YES), the sampling interval ΔT is added to an oil pressure counter Cn so that the oil pressure counter Cn is considered as new (S312), and the oil pressure counter Cn is compared with an oil pressure standard timer value Tn1 (S313).

Here, the oil pressure standard timer value Tn1 is set to a value that can detect that De>γ is continued twice or more in order to eliminate the influence by noise (for example, value for 100 ms or more).

However, oil pressure standard timer value Tn1 is set as the time within time after the brake is operated until the speed (acceleration) of the vehicle actually changes.

The processing of S312 and S313 eliminates the influence of noise, and only an intention that the driver is going to decelerate the vehicle is detected.

If Cn>Tn1 (S313: YES), a deceleration mode Bd1 corresponding to a Bd1 filter (with no filter (or filter reset)) is decided so that the actuator can respond quickly to the pitch angle change without filtering (S314), and the operation judging control process is ended.

If Cn≦Tn1 (S313: NO), the operation judging control process is ended.

On the other hand, if De≦γ (S311: NO) in the process of S311, the oil pressure counter Cn is reset (S315), and the operation judging control process is ended.

After the operation judging control process is completed, processing from S201 is performed (refer to FIG. 3).

However, when the filter is determined by the operation judging control process (when the processing of S304 or S314 is performed), the operation judging control process is completed without performing the processing from S201.

In the processing from S201, the vehicle speed V is judged first whether it is under 2 [km/h] that is set beforehand (S201).

When the judgment condition of S201 is satisfied and the vehicle speed V is presumed as being under 2 [km/h], and the vehicle is stopped (S201: YES), a stop mode A corresponding to an A filter (having no filter (or filter reset) or 1 sec. moving average filter) is decided for not filtering since a big pitch angle change is expected by loading etc., or in order the actuator to respond quickly to the pitch angle change by filtering weakly, the processing is ended.

On the other hand, if the judgment condition of S201 is not satisfied (S201: NO), and when the vehicle speed V is more than 2 [km/h], it is judged at step S203 whether the acceleration a (=dV/dt) computed by differentiating the vehicle speed V exceeds the predetermined acceleration 2 [m/s²].

When the judgment condition of S203 is satisfied and acceleration α is exceeding 2 [m/s2] (S203: YES), the previous control mode is judged as to whether it was an acceleration mode (S204).

When the judgment condition of S204 is not satisfied (S204: NO), an acceleration mode counter TBa is set to “0” (S205), and processing proceeds to S206, which will be described later.

When the judgment condition of S204 is satisfied and the previous control mode is the acceleration mode (S204: YES), processing shifts to S206 immediately, and the sampling interval ΔT is added to the acceleration mode counter TBa so that the acceleration mode counter TBa is considered as new (S206).

Then the acceleration mode counter TBa is whether exceeding an initial mode time limit Tm is judged (S207).

If the judgment condition of S207 is not satisfied and the acceleration mode counter TBa is below the initial mode time limit Tm (S207: NO), the initial mode Ba1 of acceleration corresponding to the Ba1 filter (with no filter (or filter reset)) is decided (S208) in order that the actuator can quickly respond to the pitch angle change without using the filter, and the processing is ended.

If the judgment condition of S207 is satisfied and the acceleration mode counter TBa exceeds the initial mode time limit Tm (S207: YES), the acceleration mode Ba2 corresponding to a Ba2 filter (1 sec. moving average filter) is decided so that the actuator can quickly respond to the pitch angle change by filtering very weakly, and the processing is ended.

If the judgment condition of S203 is not satisfied, and the acceleration α is below 2 [m/s²] (S203: NO), the acceleration α is judged whether it is less than −2 [m/s²] (S210).

If the judgment condition of S210 is satisfied and the acceleration α is below −2 [m/s²] (S210: YES), the previous control mode is judged as to whether it was a deceleration mode of a filter domain Bd (S211).

When the judgment condition of S211 is not satisfied (S211: NO), the deceleration mode counter TBd is set to “0” (S212), and the step is shifted to the processing of S213 which is mentioned later.

If the judgment condition of S211 is satisfied and the previous control mode is the deceleration mode of the filter domain Bd (S211: YES), the step is shifted to S213 immediately, and the sampling interval ΔT is added to the deceleration mode counter TBd, and the deceleration mode counter TBd is considered as new (S213).

Then, the deceleration mode counter TBd is judged whether it exceeds the initial mode time limit Tm (S214).

If the judgment condition of S214 is not satisfied and the deceleration mode counter TBd is below the initial mode time limit Tm, (S214: NO) the deceleration mode Bd1 corresponding to the Bd1 filter (with no filter (or filter reset)) is decided (S215) in order for the actuator to respond quickly to the pitch angle change without filtering, since the pitch angle change is large, and the processing is ended.

On the other hand, if the judgment condition of S214 is satisfied and the deceleration mode counter TBd is exceeding the initial mode time limit Tm (S214: YES), the deceleration mode Bd2 corresponding to Bd2 filter (1 sec. moving average filter) (S216) so that the actuator can quickly respond to the pitch angle change by filtering weakly, since the pitch angle change is large, then this subroutine is ended.

If the judgment condition of S210 is not satisfied and the acceleration is more than α−2 [m/s²] (S210: NO), the previous control mode is judged whether the constant speed modes of the filter domain C (S217).

If the judgment condition of S217 is not satisfied (S217: NO), the constant speed mode counter TC is set to 0 (S218), and the step is shifted to the processing of S219 which is mentioned later.

In addition, if the judgment condition of S217 is satisfied and the previous control mode is the constant speed mode of the filter domain C (S217: YES), the sampling interval ΔT is added to the constant speed mode counter TC, and the constant speed mode counter TC is considered as new (S219).

Next, the constant speed mode counter TC is judged whether it exceeds the initial mode time limit Tm (S220).

If the judgment condition of S220 is not satisfied and the constant speed mode counter TC is below the initial mode time limit Tm (S220), a constant speed initial mode C1 corresponding to C1 filter (having no filter (or filter reset) or 1 sec. moving average filter) (S221), so that the actuator can quickly respond to the pitch angle change by not filtering or filtering weakly, since it is an early stages of constant speed and the pitch angle change is large, then the processing is ended.

When the judgment condition of S220 is satisfied and the constant speed mode counter TC exceeds the initial mode time limit Tm (S220: YES), the step is shifted to S222, and a constant speed mode C2 corresponding to a C2 filter of a C filter domain (10 sec. moving average filter) is selected, so that the actuator does not respond by filtering strongly for removing a high frequency ingredient of the vibration at the time of traveling or an unevenness of a road surface, since there is usually no big pitch angle change is expected, and the processing is ended.

### The Effect by the Embodiment

In the light control device 1 explained above, the ECU 20 changes the light axis directions by the response set with the predetermined filter so that the light axis directions of the headlight 30L (30R) approaches the angle beforehand set to align them correctly with the road surface according to an inclination of the vehicle acquired by light control process.

When the detection result showing that the driver of the vehicle performs the changing operation that gives the change of speed or acceleration to the vehicle concerned is acquired, the ECU 20 is set so that either selects a filter giving a better response or selects no filter as appropriate for giving the best response characteristics (responsiveness) according to a detection result of the changing operation by the operation judging control process.

According to the light control device 1, the inclination of the vehicle changed by acceleration or deceleration is detectable in advance.

Before the inclination of the vehicle changes, the filter that determines the response at the time of making the light axis directions change may be changed into a filter that can change the light axis directions promptly or not to use a filter, as appropriate.

Therefore, when at the time other than acceleration or deceleration of the vehicle, troublesome frequent light axis direction changes can be prevented, and when accelerating or decelerating the vehicle, sharp up and down changing of the light axis direction can be prevented.

The ECU 20 presumes that the detection result of the changing operation by the driver of the vehicle is acquired when the detection result of the changing operation is acquired continuously in the judging standard time set as within a time after the driver of the vehicle performs the changing operation until the acceleration of the vehicle actually changes.

According to the light control device 1, when the changing operation is detected in a very short period of time (less than judging standard time) by incorrect detection of noise etc., it is judged that the cause is not a true driver-initiated acceleration or deceleration. Therefore, unnecessary control by incorrect detection can be prevented.

The ECU 20 acquires the detection result of the operation of the accelerator or the brake of the vehicle as the changing operation.

According to the ECU 20 mentioned above, the changing operation is detectable with a simpler composition.

### Other Embodiments

The embodiment of the present invention can take various forms, as long as it is not limited to the above-mentioned embodiment at all and is within the technical scope of this invention.

For example, although the detection result of the operation of the accelerator or the brake of the vehicle is acquired as the changing operation in the above-mentioned embodiment, the composition that detects the changing operation may be adopted by detecting a driver's viewing direction or muscle motion.

In addition, although the interface circuit 25 filters have a predetermined response to the pitch angle θp in the above-mentioned embodiment, the amount of control of light axis (the amount of the change of the actuator desired value θa) in the case of processing of S106 may be filtered with the predetermined response.

A control speed set etc. to the actuator 35L (35R) may be changed according to the selected filter.

The interface circuit 25 may equalize the inputs (for example, 5 inputs) acquired by the oil pressure sensor 13 or the opening degree sensor 14.

Accordingly, the influence of noise from the oil pressure sensor 13 or the opening degree sensor 14 on the control of the light axis directions can be reduced.

What is claimed is:

1. A light control device for vehicles that controls a light axis direction of a headlight in the vehicles comprising:
an inclination acquisition means that acquires a detection result of an inclination of the vehicle;
a light axis direction changing means that changes a direction of the light axis by a response modified by a predetermined filter, so that the light axis direction of the headlight approaches an angle beforehand set to align it with the road surface according to the acquired inclination of the vehicle;
an operation acquisition means that acquires a detection result of a changing operation in which a driver of the vehicle performs a change of speed or acceleration of the vehicle; and
a filter setting means that either selects a filter giving a better response or selects no filter as appropriate for giving the best response characteristics (responsiveness) according to a detection result of the changing operation by the driver of the vehicle.

2. The light control device for vehicles according to claim 1,
the filter setting means presumes that the detection result of the changing operation by the driver of the vehicles is acquired when the detection result of the changing operation is acquired continuously in a judging standard time set as within a time after the driver of the vehicles performs the changing operation until an acceleration or speed of the vehicles actually changes.

3. The light control device for vehicles according to claim 1,
the operation acquisition means acquires the detection result of an operation of an accelerator or a brake of the vehicles as the changing operation.

4. The light control device for vehicles according to claim 2,
the operation acquisition means acquires the detection result of an operation of an accelerator or a brake of the vehicles as the changing operation.

5. The light control device for vehicles according to claim 1,
a computer is made to function by a light control program as a means to constitute the light control device.

6. The light control device for vehicles according to claim 2,
a computer is made to function by a light control program as a means to constitute the light control device.

7. The light control device for vehicles according to claim 3,
a computer is made to function by a light control program as a means to constitute the light control device.

8. The light control device for vehicles according to claim 4,
a computer is made to function by a light control program as a means to constitute the light control device.
